(19) United States
(12) Patent Application Publication
(10) Pub. No.: US 2025/0368243 A1
(43) Pub. Date: Dec. 4, 2025

(54) SEAT FOLDING CART

(71) Applicant: Qingdao Ritashaw Machinery Co., Ltd., Qingdao (CN)

(72) Inventor: Zhenhua YANG, Qingdao (CN)

(73) Assignee: Qingdao Ritashaw Machinery Co., Ltd., Qingdao (CN)

(21) Appl. No.: 18/733,104

(22) Filed: Jun. 4, 2024

(51) Int. Cl. B62B 3/00; B62B 3/02; B62B 5/06; B62B 5/08

(52) U.S. Cl. CPC B62B 3/007; B62B 3/025; B62B 5/065; B62B 5/085; B62B 2205/06

(57) ABSTRACT

The present invention relates to the technical field of folding carts, and in particular to a seat folding cart comprising: a front frame bottom, a rear frame bottom, a front retaining frame, a rear retaining frame, and a telescoping frame, the front frame bottom and the rear frame bottom being rotatably connected by means of connecting plates. Outer ends of the front frame bottom and the rear frame bottom at two sides thereof are stretched outwardly until inner ends of the front frame bottom and the rear frame bottom are pressed against limiting pillars, thus serving to allow the cart body to be easily folded and unfolded. When the cart body is unfolded, goods are placed on the cart body, which can then be pulled to move carrying the goods.

### TECHNICAL FIELD

The present invention relates to the technical field of folding carts, and in particular to a seat folding cart.

### BACKGROUND ART

As transport vehicles that are pushed and pulled by human power, carts are indispensable transport tools in everyday life as they can work in places where it is not convenient to use motorized vehicles and they are very handy for moving lighter items over short distances. At present, there are two common types of carts, one of which is a non-foldable cart consisting of rollers and pullers, and the like, provided on a flat loading platform, while the other one is a cart that can be folded for storage.

The folding method in the prior art generally applies force to each side face from the outside to the inside to make each side face approach the load-bearing part at the center. Such a folding method is laborious and results in inconvenient folding; and since the cart body frame mainly consists of four side faces, in the absence of a connecting support bar connected to the upper and lower hinged ends at the side faces, it cannot be suitable for supporting high strength and weight. Moreover, for the existing folding cart, since there is no fixing structure provided, when the folding cart is subjected to force when being unfolded, it will fold on its own due to external force, which causes inconvenience in use. In this regard, the present invention proposes a seat folding cart for solving the above problem.

### SUMMARY OF THE INVENTION

It is an objective of the present invention to provide a seat folding cart for solving the above problems raised in the background art part.

In order to achieve the above objective, the present invention provides the following technical solution: a seat folding cart comprising: a front frame bottom, a rear frame bottom, a front retaining frame, a rear retaining frame, and a telescoping frame, the front frame bottom and the rear frame bottom being rotatably connected by means of connecting plates, there being front wheel bodies mounted on the left and right sides at a lower end on a side of the front frame bottom that is far from the rear frame bottom, and there being rear wheel bodies mounted on the left and right sides at a lower end on a side of the rear frame bottom that is far from the front frame bottom, wherein lower ends of the front retaining frame are fixedly mounted to upper ends of the two front wheel bodies and lower ends of the rear retaining frame are fixedly mounted to upper ends of the rear wheel bodies.

the telescoping frame is rotatably connected between one side of the front retaining frame and one side of the rear retaining frame, and there is an enclosure piece I sleeved on outer sides of the front retaining frame and the rear retaining frame as well as the front frame bottom and the rear frame bottom, with a cloth pocket being attached to one side of the enclosure piece I by means of zippers; and there is a backrest body removably mounted on one side of the front retaining frame and one side of the rear retaining frame.

Preferably, there are two said connecting plates provided, wherein the connecting plates are U-shaped, and the two connecting plates are both provided with connecting grooves on inner sides of upper ends thereof, the connecting grooves and the connecting plates being in communication internally, and there is a fixing bar provided between the two connecting plates, two ends of the fixing bar being inserted into the two connecting grooves and welded to inner walls of the connecting plates, respectively.

Preferably, the front frame bottom and the rear frame bottom have the same structure, and the front frame bottom and the rear frame bottom are symmetrically provided on outer sides of the two connecting plates and each have one end inserted into inner sides of upper ends of the connecting plates and rotatably connected by means of shaft pins, the front frame bottom and the rear frame bottom are each provided with bottom frame connecting bars on the left and right sides at the lower ends, the bottom frame connecting bars each having one end inserted into an inner side of a lower end of the corresponding connecting plate and rotatably connected by means of a shaft pin, and there are limiting pillars fixedly mounted on the left and right sides of the upper end of each of the connecting plates, the limiting pillars being located obliquely below inner ends of the front frame bottom and the rear frame bottom and when the front frame bottom and the rear frame bottom are completely unfolded, lower sides of the inner ends thereof being abutted against upper ends of the limiting pillars.

Preferably, there is a cross bar fixedly mounted between mounting frames for the two front wheel bodies, and a connecting block is fixedly mounted on an inner side of an upper end of the mounting frame for each of the front wheel bodies.

Preferably, one end of the front frame bottom that is far from the connecting plates is inserted into inner sides of the front retaining frame and is rotatably connected to inner walls of the front retaining frame by means of screws, and at the same time, one end, which is far from the connecting plates, of each of the bottom frame connecting bars at the lower end of the front frame bottom is rotatably connected to the connecting block by means of a bolt.

Preferably, there is a cross bar fixedly mounted between mounting frames for the two rear wheel bodies, and there is a telescoping push bar rotatably connected at a center of an upper end of the cross bar, with a handle fixedly mounted at an upper end of the telescoping push bar.

Preferably, there is an elastic clamp block corresponding to the telescoping push bar fixedly mounted on a side wall at an outer side of an upper end of the rear retaining frame, the elastic clamp block being U-shaped and an outer wall of the telescoping push bar being clampable to an inner side of the elastic clamp block.

Preferably, one end of the rear frame bottom that is far from the connecting plates is inserted into inner sides of the rear retaining frame and is rotatably connected to inner walls of the rear retaining frame by means of screws, and at the same time, one end, which is far from the connecting plates, of each of the bottom frame connecting bars at the lower end of the rear frame bottom is rotatably connected to the connecting block by means of a bolt.

Preferably, the enclosure piece I is provided with sleeves at all outer ends and is sleeved on outer walls of the front retaining frame and the rear retaining frame as well as the front frame bottom and the rear frame bottom by means of the sleeves, the enclosure piece I wraps the telescoping frame, and the enclosure piece I and the cloth pocket are mounted with the zippers at all connections thereof and are connected by zipper headers.

Preferably, the backrest body comprises two extension bars and plug-in bars, wherein upper ends of the plug-in bars are fixedly mounted to lower ends of the extension bars and lower ends of the two plug-in bars are inserted into upper ends of one end of the front retaining frame and one end of the rear retaining frame, and there is an enclosure piece II sleeved between the two extension bars by means of the sleeves and the backrest body is located at an upper end of the telescoping frame.

Compared with the prior art, the beneficial effects of the present invention are as follows.

When it is needed for use, with a fixing bar of the cart body as the center, outer ends of the front frame bottom and the rear frame bottom at two sides thereof are stretched outwardly until inner ends of the front frame bottom and the rear frame bottom are pressed against limiting pillars, so that the cart body is unfolded, thus serving to allow the cart body to be easily folded and unfolded.

When the cart body is unfolded, goods are placed on the cart body, which can then be pulled to move carrying the goods, while when it is needed to seat a person, a cloth pocket is removed, and an upper end of the cart body is made to turn into a seat state in seconds, then the rider can be seated at the upper end.

### BRIEF DESCRIPTION OF THE DRAWINGS

FIG. 1 is a three-dimensional schematic diagram of the overall structure of the present invention;

FIG. 2 is a schematic diagram of the structure after a cloth pocket has been removed in the present invention;

FIG. 3 is a schematic diagram of the connection of a front frame bottom and a rear frame bottom in the present invention;

FIG. 4 is a schematic diagram of the unfolded cart body skeleton in the present invention;

FIG. 5 is an enlarged view of the structure of region A in FIG. 4 of the present invention; FIG. 6 is a schematic diagram of the semi-folded cart body skeleton in the present invention; and

FIG. 7 is a schematic diagram of the folded cart body skeleton in the present invention.

In the figures: 1. front frame bottom; 2. rear frame bottom; 3. connecting plate; 4. connecting groove; 5. fixing bar; 6. limiting pillar; 7. bottom frame connecting bar; 8. front retaining frame; 9. rear retaining frame; 10. extension bar; 11. plug-in bar; 12. telescoping push bar; 13. handle; 14. telescoping frame; 15. front wheel body; 16. rear wheel body; 17. cross bar; 18. connecting block; 19. elastic clamp block; 20. enclosure piece I; 21. zipper; 22. zipper header; 23. cloth pocket; 24. enclosure piece II; 25. sleeve.

### DETAILED DESCRIPTION OF EMBODIMENTS

In order to provide a clear and complete description of the objective, the technical solution, and the advantages of the present invention, the following embodiments of the present invention are described in further detail in conjunction with the accompanying drawings. It should be understood that the specific embodiments described herein are part of the embodiments of the present invention and not all of the embodiments, and are only used to explain the embodiments of the present invention, and are not used to limit the embodiments of the present invention, and all other embodiments that would be obtained by those of ordinary skill in the art without expending inventive effort shall all fall within the scope of protection of the present invention.

In the description of the present invention, it is to be noted that the orientation or location relationships indicated by the terms “center”, “middle”, “up”, “down”, “left”, “right”, “inside”, “outside”, “top”, “bottom”, “side”, “vertical”, “horizontal”, and the like are based on the orientation or location relationships shown in the accompanying drawings, and are only for the convenience and simplification of the description of the present invention, but do not indicate or imply that the devices or components referred to must have particular orientations, be constructed and operated in particular orientations, and therefore cannot be construed as a limitation of the present invention. Furthermore, the terms “one”, “first”, “second”, “third”, “fourth”, “fifth”, “sixth”, and the like are used for descriptive purposes only and are not to be understood as indicating or implying relative importance.

In the description of the present invention, it is to be noted that, unless otherwise expressly provided and limited, the terms “mounted”, “connected”, “connecting” are to be understood in a broad sense, for example, as a fixed connection or as a detachable connection. For example, it may be a fixed connection, a removable connection, or a connection in one piece; it may be a mechanical connection or an electrical connection; it may be a direct connection or an indirect connection through an intermediate medium; or it may be a communication between the interior of two components. For those of ordinary skills in the art, the specific meaning of the terms mentioned above in the present invention should be construed according to specific circumstances.

For the purposes of brevity and illustration, the principles of the embodiments are described primarily by reference to examples. In the following description, many specific details are presented to provide a thorough understanding of the embodiments. It is apparent, however, to those of ordinary skill in the art that the embodiments may not be limited in practice to these specific details. In some examples, the well-known methods and structures are not described in detail to avoid unnecessarily making these embodiments difficult to understand. In addition, all embodiments may be used in combination with each other.

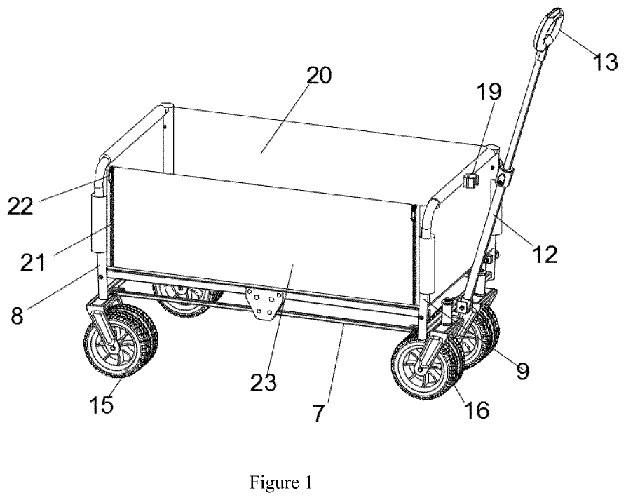

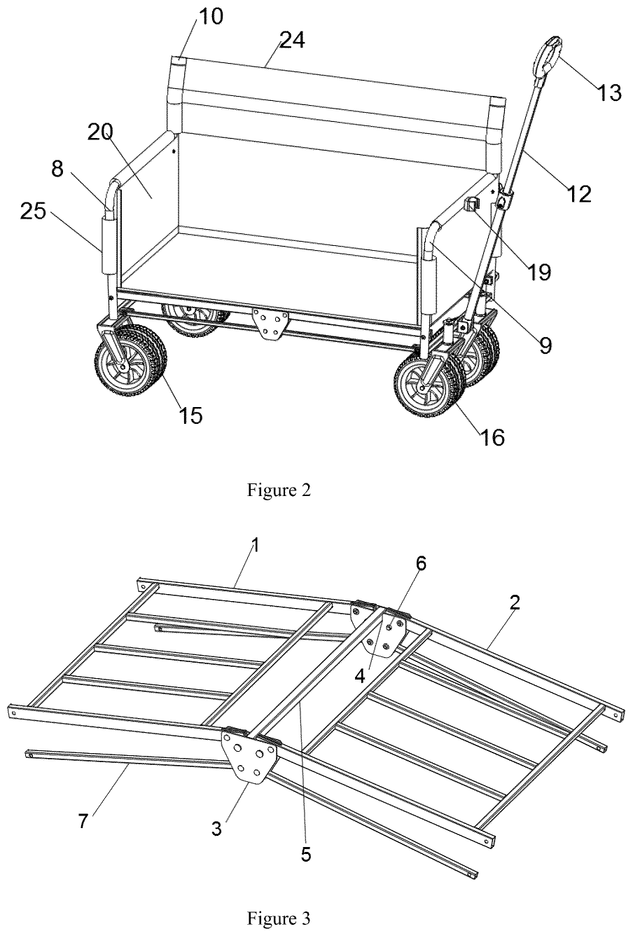

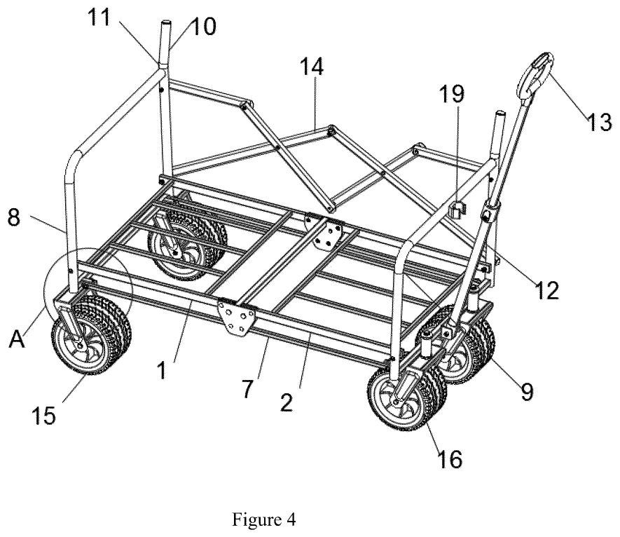

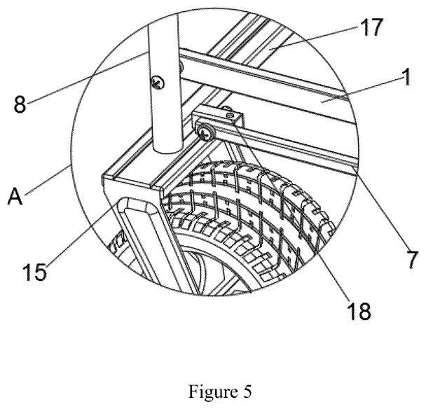

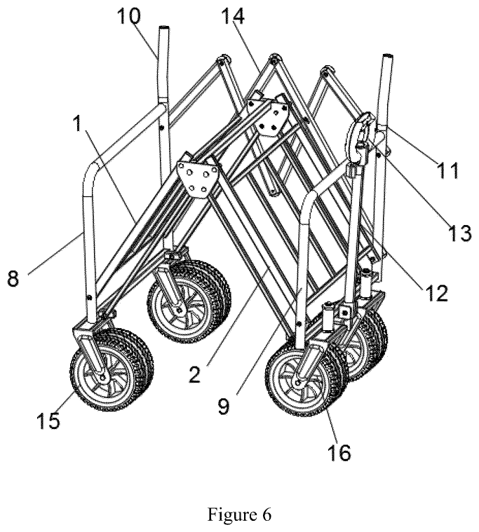

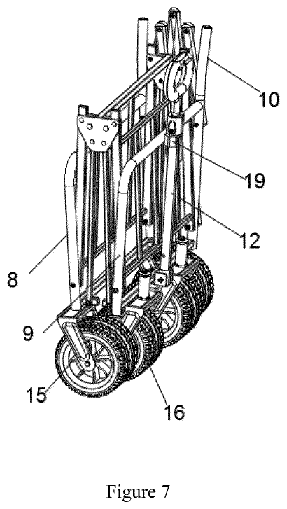

Referring to FIGS. 1 to 7, the present invention provides a technical solution: a seat folding cart comprising: a front frame bottom 1, a rear frame bottom 2, a front retaining frame 8, a rear retaining frame 9, and a telescoping frame 14, the front frame bottom 1 and the rear frame bottom 2 being rotatably connected by means of connecting plates 3, The front frame bottom 1 and the rear frame bottom 2 are formed by welding metal tubes together, and the side walls of both the front and rear ends of the front frame bottom 1 and the rear frame bottom 2 extend out of the front and rear ends. there are two connecting plates 3 provided, wherein one end of the front frame bottom 1 and one end of the rear frame bottom 2 are located between the two connecting plates 3, the connecting plates 3 are U-shaped, and the two connecting plates 3 are both provided with connecting grooves 4 on inner sides of upper ends thereof, the connecting grooves 4 and the connecting plates 3 being in communication internally, and there is a fixing bar 5 provided between the two connecting plates 3, two ends of the fixing bar 5 being inserted into the two connecting grooves 4 and welded to inner walls of the connecting plates 3, respectively, thereby fixing the two connecting plates 3 together.

The front frame bottom 1 and the rear frame bottom 2 have the same structure, and the front frame bottom 1 and the rear frame bottom 2 are symmetrically provided on the front and rear sides of the two connecting plates 3 and each have extension bars at one end inserted into inner sides of upper ends of the connecting plates 3 and rotatably connected by means of shaft pins, One end of the front frame bottom 1 and one end of the rear frame bottom 2 are rotated with the shaft pins as the center of the circle, which allows the front frame bottom 1 and the rear frame bottom 2 to be horizontally unfolded or to be rotated and stacked together. the front frame bottom 1 and the rear frame bottom 2 are each provided with bottom frame connecting bars 7 on the left and right sides at the lower ends, one end of each of the bottom frame connecting bars 7 being inserted into an inner side of a lower end of the corresponding connecting plate 3 and rotatably connected by means of a shaft pin, and the one end of the bottom frame connecting bar 7 being rotatable on the connecting plate 3 with the shaft pin as the center of the circle. There are limiting pillars 6 fixedly mounted on the left and right sides of the upper end of each of the connecting plates 3, the limiting pillars 6 being located obliquely below inner ends of the front frame bottom 1 and the rear frame bottom 2 and when the front frame bottom 1 and the rear frame bottom 2 are completely unfolded, lower sides of the inner ends thereof being abutted against upper ends of the limiting pillars 6, thereby limiting the positions of the front frame bottom 1 and the rear frame bottom 2 to prohibit one end of the front frame bottom 1 and one end of the rear frame bottom 2 from continuing to rotate downwardly, thus allowing the front frame bottom 1 and the rear frame bottom 2 to keep in a horizontally unfolded state.

There are front wheel bodies 15 mounted on the left and right sides at a lower end on a side of the front frame bottom 1 that is far from the rear frame bottom 2, and there are rear wheel bodies 16 mounted on the left and right sides at a lower end on a side of the rear frame bottom 2 that is far from the front frame bottom 1. Lower ends of the front retaining frame 8 are fixedly mounted to upper ends of the two front wheel bodies 15 and lower ends of the rear retaining frame 9 are fixedly mounted to upper ends of the rear wheel bodies 16. In the horizontal direction, the two rear wheel bodies 16 are located on the inner sides of the two front wheel bodies 15, so that when the cart body is folded, the two rear wheel bodies 16 are located on the inner sides of the two front wheel bodies 15, which allows the two rear wheel bodies 16 and the two front wheel bodies 15 to be in a vertical straight line, thus reducing the volume of the cart body.

There is a cross bar 17 fixedly mounted between mounting frames for the two front wheel bodies 15, and there is a connecting block 18 fixedly mounted on an inner side of an upper end of the mounting frame for each of the front wheel bodies 15. One end of the front frame bottom 1 that is far from the connecting plates 3 is inserted into inner sides of the front retaining frame 8 and is fixedly connected to inner walls of the front retaining frame 8 by means of screws, and at the same time, one end, which is far from the connecting plates 3, of each of the bottom frame connecting bars 7 at the lower end of the front frame bottom 1 is fixedly connected to the connecting block 18 by means of a bolt, thereby fixedly connecting the other end of the front frame bottom 1 and the other end of the bottom frame connecting bar 7 to the upper ends of the two front wheel bodies 15. There is a cross bar 17 fixedly mounted between mounting frames for the two rear wheel bodies 16. One end of the rear frame bottom 2 that is far from the connecting plates 3 is inserted into inner sides of the rear retaining frame 9 and is fixedly connected to inner walls of the rear retaining frame 9 by means of screws, and at the same time, one end, which is far from the connecting plates 3, of each of the bottom frame connecting bars 7 at the lower end of the rear frame bottom 2 is fixedly connected to the connecting block 18 by means of a bolt, thereby fixedly connecting the other end of the rear frame bottom 2 and the other end of the bottom frame connecting bar 7 to the upper ends of the two rear wheel bodies 16. When folding the front frame bottom 1 and the rear frame bottom 2, the front wheel bodies 15 and the rear wheel bodies 16 can be folded together, thereby reducing the volume of the cart body after folding.

There is a telescoping push bar 12 rotatably connected at a center of an upper end of the cross bar 17 (the telescoping push bar 12 belongs to the prior art, so it will not be discussed herein), with a handle 13 fixedly mounted at an upper end of the telescoping push bar 12. For the telescoping push bar 12, the height of the handle 13 can be adjusted according to the height of the user, and thus it is easy to be used by people of different heights, and the user can pull the cart by holding the handle 13. There is an elastic clamp block 19 corresponding to the telescoping push bar 12 fixedly mounted on a side wall at an outer side of an upper end of the rear retaining frame 9, the elastic clamp block 19 being U-shaped and an outer wall of the telescoping push bar 12 being clampable to an inner side of the elastic clamp block 19. When folding the cart body, the telescoping push bar 12 is retracted to a minimum state, and then the telescoping push bar 12 is clamped within the elastic clamp block 19, thereby facilitating fixation thereof.

The telescoping frame 14 is rotatably connected between one side of the front retaining frame 8 and one side of the rear retaining frame 9, and the telescoping frame 14 can serve to shield one side of the front retaining frame 8 and one side of the rear retaining frame 9, i.e., when goods are being placed, the telescoping frame 14 may shield the goods, and when a person is being seated, the rider may lean on one side of the telescoping frame 14. There is an enclosure piece I 20 sleeved on outer sides of the front retaining frame 8 and the rear retaining frame 9 as well as the front frame bottom 1 and the rear frame bottom 2, with a cloth pocket 23 being attached to one side of the enclosure piece I 20 by means of zippers 21. The enclosure piece I 20 is provided with sleeves 25 at all outer ends and is sleeved on outer walls of the front retaining frame 8 and the rear retaining frame 9 as well as the front frame bottom 1 and the rear frame bottom 2 by means of the sleeves 25, the enclosure piece I 20 wraps the telescoping frame 14, and the enclosure piece I 20 and the cloth pocket 23 are mounted with the zippers 21 at all connections thereof and are connected by zipper headers. This facilitates the removal and installation of the cloth pocket 23, wherein when placing goods, the cloth pocket 23 is fitted to turn it into a wagon to provide shelter for the goods, and when seating a person, the cloth pocket 23 is removed to turn the upper end of the cart body into a seat form for seating the person.

There is a backrest body removably mounted on one side of the front retaining frame 8 and one side of the rear retaining frame 9. The backrest body comprises two extension bars 10 and plug-in bars 11, wherein upper ends of the plug-in bars 11 are fixedly mounted to lower ends of the extension bars 10 and lower ends of the two plug-in bars 11 are inserted into upper ends of one end of the front retaining frame 8 and one end of the rear retaining frame 9, which facilitates disassembly and assembly of the extension bars 10 and the plug-in bars 11, thereby facilitating folding and storage, and there is an enclosure piece II 24 sleeved between the two extension bars 10 by means of the sleeves 25 and the backrest body is located at an upper end of the telescoping frame 14, and by forming a backrest body for the rider to lean against, comfort is increased.

While the device is in operation, when it is needed for use, with a fixing bar 5 of the cart body as the center, outer ends of the front frame bottom 1 and the rear frame bottom 2 at two sides thereof are stretched outwardly until inner ends of the front frame bottom 1 and the rear frame bottom 2 are pressed against limiting pillars 6, so that the cart body is unfolded, and then the goods are placed on the cart body, which can then be pulled to move carrying the goods, while when it is needed to seat a person, the cloth pocket 23 is removed, and the upper end of the cart body is made to turn into a seat state in seconds, then the rider can be seated at the upper end.

Although embodiments of the present invention have been shown and described, it will be understood to those of ordinary skill in the art that a variety of changes, modifications, substitutions, and variations may be made to these embodiments without departing from the principle and spirit of the present invention, and the scope of the present invention is limited by the appended claims and their equivalents.

1. A seat folding cart comprising: a front frame bottom (1), a rear frame bottom (2), a front retaining frame (8), a rear retaining frame (9), and a telescoping frame (14), the front frame bottom (1) and the rear frame bottom (2) being rotatably connected by means of connecting plates (3), there being front wheel bodies (15) mounted on the left and right sides at a lower end on a side of the front frame bottom (1) that is far from the rear frame bottom (2), and there being rear wheel bodies (16) mounted on the left and right sides at a lower end on a side of the rear frame bottom (2) that is far from the front frame bottom (1), wherein lower ends of the front retaining frame (8) are fixedly mounted to upper ends of the two front wheel bodies (15) and lower ends of the rear retaining frame (9) are fixedly mounted to upper ends of the rear wheel bodies (16);
the telescoping frame (14) is rotatably connected between one side of the front retaining frame (8) and one side of the rear retaining frame (9), and there is an enclosure piece I (20) sleeved on outer sides of the front retaining frame (8) and the rear retaining frame (9) as well as the front frame bottom (1) and the rear frame bottom (2), with a cloth pocket (23) being attached to one side of the enclosure piece I (20) by means of zippers (21); and
there is a backrest body removably mounted on one side of the front retaining frame (8) and one side of the rear retaining frame (9).

2. The seat folding cart according to claim 1, wherein: there are two said connecting plates (3) provided, wherein the connecting plates (3) are U-shaped, and the two connecting plates (3) are both provided with connecting grooves (4) on inner sides of upper ends thereof, the connecting grooves (4) and the connecting plates (3) being in communication internally, and there is a fixing bar (5) provided between the two connecting plates (3), two ends of the fixing bar (5) being inserted into the two connecting grooves (4) and welded to inner walls of the connecting plates (3), respectively.

3. The seat folding cart according to claim 1, wherein: the front frame bottom (1) and the rear frame bottom (2) have the same structure, and the front frame bottom (1) and the rear frame bottom (2) are symmetrically provided on outer sides of the two connecting plates (3) and each have one end inserted into inner sides of upper ends of the connecting plates (3) and rotatably connected by means of shaft pins, the front frame bottom (1) and the rear frame bottom (2) are each provided with bottom frame connecting bars (7) on the left and right sides at the lower ends, one end of each of the bottom frame connecting bars (7) being inserted into an inner side of a lower end of the corresponding connecting plate (3) and rotatably connected by means of a shaft pin, and there are limiting pillars (6) fixedly mounted on the left and right sides of the upper end of each of the connecting plates (3), the limiting pillars (6) being located obliquely below inner ends of the front frame bottom (1) and the rear frame bottom (2) and when the front frame bottom (1) and the rear frame bottom (2) are completely unfolded, lower sides of the inner ends thereof being abutted against upper ends of the limiting pillars (6).

4. The seat folding cart according to claim 1, wherein: there is a cross bar (17) fixedly mounted between mounting frames for the two front wheel bodies (15), and there is a connecting block (18) fixedly mounted on an inner side of an upper end of the mounting frame for each of the front wheel bodies (15).

5. The seat folding cart according to claim 4, wherein: one end of the front frame bottom (1) that is far from the connecting plates (3) is inserted into inner sides of the front retaining frame (8) and is rotatably connected to inner walls of the front retaining frame (8) by means of screws, and at the same time, one end, which is far from the connecting plates (3), of each of the bottom frame connecting bars (7) at the lower end of the front frame bottom (1) is rotatably connected to the connecting block (18) by means of a bolt.

6. The seat folding cart according to claim 1, wherein: there is a cross bar (17) fixedly mounted between mounting frames for the two rear wheel bodies (16), and there is a telescoping push bar (12) rotatably connected at a center of an upper end of the cross bar (17), with a handle (13) fixedly mounted at an upper end of the telescoping push bar (12).

7. The seat folding cart according to claim 6, wherein: there is an elastic clamp block (19) corresponding to the telescoping push bar (12) fixedly mounted on a side wall at an outer side of an upper end of the rear retaining frame (9), the elastic clamp block (19) being U-shaped and an outer wall of the telescoping push bar (12) being clampable to an inner side of the elastic clamp block (19).

8. The seat folding cart according to claim 4, wherein: one end of the rear frame bottom (2) that is far from the connecting plates (3) is inserted into inner sides of the rear retaining frame (9) and is rotatably connected to inner walls of the rear retaining frame (9) by means of screws, and at the same time, one end, which is far from the connecting plates (3), of each of the bottom frame connecting bars (7) at the lower end of the rear frame bottom (2) is rotatably connected to the connecting block (18) by means of a bolt.

9. The seat folding cart according to claim 1, wherein: the enclosure piece I (20) is provided with sleeves (25) at all outer ends and is sleeved on outer walls of the front retaining frame (8) and the rear retaining frame (9) as well as the front frame bottom (1) and the rear frame bottom (2) by means of the sleeves (25), the enclosure piece I (20) wraps the telescoping frame (14), and the enclosure piece I (20) and the cloth pocket (23) are mounted with the zippers (21) at all connections thereof and are connected by zipper headers (21).

10. The seat folding cart according to claim 1, wherein: the backrest body comprises two extension bars (10) and plug-in bars (11), wherein upper ends of the plug-in bars (11) are fixedly mounted to lower ends of the extension bars (10) and lower ends of the two plug-in bars (11) are inserted into upper ends of one end of the front retaining frame (8) and one end of the rear retaining frame (9), and there is an enclosure piece II (24) sleeved between the two extension bars (10) by means of the sleeves (25) and the backrest body is located at an upper end of the telescoping frame (14).
